(19) United States
(12) Patent Application Publication
(10) Pub. No.: US 2022/0021774 A1
(43) Pub. Date: Jan. 20, 2022

(54) INFORMATION PROCESSING APPARATUS AND NON-TRANSITORY COMPUTER READABLE MEDIUM

(71) Applicant: FUJIFILM BUSINESS INNOVATION CORP., Tokyo (JP)

(72) Inventor: Tetsuo SUZUKI, Kanagawa (JP)

(73) Assignee: FUJIFILM BUSINESS INNOVATION CORP., Tokyo (JP)

(21) Appl. No.: 17/180,016

(22) Filed: Feb. 19, 2021

(30) Foreign Application Priority Data
Jul. 16, 2020 (JP) 2020-122326

(51) Int. Cl. H04N 1/00

(52) U.S. Cl. CPC H04N 1/00506; H04N 2201/0094; H04N 1/00413; H04N 1/00411

(57) ABSTRACT

An information processing apparatus includes a memory and a processor configured to, in display of at least two display areas on a display apparatus, when superimposition of two display areas hinders an operation using an operation button in the lower display area, change the arrangement position of the operation button in the lower display area hidden by the upper display area so as to make the operation button operable without change of the display size and position of the lower display area.

### CROSS-REFERENCE TO RELATED APPLICATIONS

This application is based on and claims priority under 35 USC 119 from Japanese Patent Application No. 2020-122326 filed Jul. 16, 2020.

### BACKGROUND

### (i) Technical Field

The present disclosure relates to an information processing apparatus and a non-transitory computer readable medium.

### (ii) Related Art

Japanese Unexamined Patent Application Publication No. 10-11263 discloses a multi-window system which, when two windows are superimposed on each other and are displayed, reduces the lower window and moves the reduced window to a position at which the moved window is not superimposed on the upper window.

Japanese Unexamined Patent Application Publication No. 2004-234426 discloses a window display apparatus which, when a certain window is moved so as to be superimposed on a different window, moves the different window to a position at which operation buttons in the different window are displayed.

Japanese Unexamined Patent Application Publication No. 2009-169548 discloses an information processing apparatus which, when a button in a currently-displayed window is operated to display a new window, displays the new window at a position at which the new window is not superimposed on components which are prohibited from being invisible and which are displayed in the lower window.

### SUMMARY

Aspects of non-limiting embodiments of the present disclosure relate to an information processing apparatus and a non-transitory computer readable medium which, when superimposition of two display areas hinders an operation on an operation button in the lower display area, enable the operation button in the lower display area to be operated without change of the display size and position of the lower display area.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a memory and a processor configured to, in display of at least two display areas on a display apparatus, when superimposition of two display areas hinders an operation using an operation button in the lower display area, change the arrangement position of the operation button in the lower display area hidden by the upper display area so as to make the operation button operable without change of the display size and position of the lower display area.

### BRIEF DESCRIPTION OF THE DRAWINGS

Exemplary embodiment of the present disclosure will be described in detail based on the following figures, wherein:

FIG. 1 is a diagram illustrating the configuration of an image forming system according to an exemplary embodiment of the present disclosure;

FIG. 2 is a diagram illustrating an operation screen example of an image forming apparatus according to an exemplary embodiment of the present disclosure;

FIGS. 3A to 3F are diagrams illustrating an operation example on an operation screen of an image forming apparatus according to a comparison example;

FIGS. 4A and 4B are diagrams illustrating operation screen examples of an image forming apparatus according to a comparison example;

FIG. 5 is a block diagram illustrating the hardware configuration of an image forming apparatus according to an exemplary embodiment of the present disclosure;

FIG. 6 is a block diagram illustrating the functional configuration of an image forming apparatus according to an exemplary embodiment of the present disclosure;

FIGS. 7A and 7B are diagrams illustrating an operation example on an operation screen of an image forming apparatus according to an exemplary embodiment of the present disclosure;

FIG. 8 is a flowchart of operations of an image forming apparatus according to an exemplary embodiment of the present disclosure;

FIG. 9A is a diagram illustrating an operation screen example of an image forming apparatus according to an exemplary embodiment of the present disclosure;

FIG. 9B is a diagram for describing an internal process of the operation screen of the image forming apparatus after the state illustrated in FIG. 9A;

FIG. 10A is a diagram for describing an internal process of the operation screen of the image forming apparatus after the state illustrated in FIG. 9B;

FIG. 10B is a diagram illustrating an operation screen example of the image forming apparatus after the state illustrated in FIG. 10A;

FIG. 11A is a diagram illustrating an operation screen example of an image forming apparatus according to an exemplary embodiment of the present disclosure;

FIG. 11B is a diagram for describing an internal process of the operation screen of the image forming apparatus after the state illustrated in FIG. 11A;

FIG. 12A is a diagram for describing an internal process of the operation screen of the image forming apparatus after the state illustrated in FIG. 11B;

FIG. 12B is a diagram for describing an internal process of the operation screen of the image forming apparatus after the state illustrated in FIG. 12A;

FIG. 13A is a diagram for describing an internal process of the operation screen of the image forming apparatus after the state illustrated in FIG. 12B; and

FIG. 13B is a diagram illustrating an operation screen example of the image forming apparatus after the state illustrated in FIG. 13A.

### DETAILED DESCRIPTION

An exemplary embodiment of the present disclosure will be described in detail by referring to the drawings.

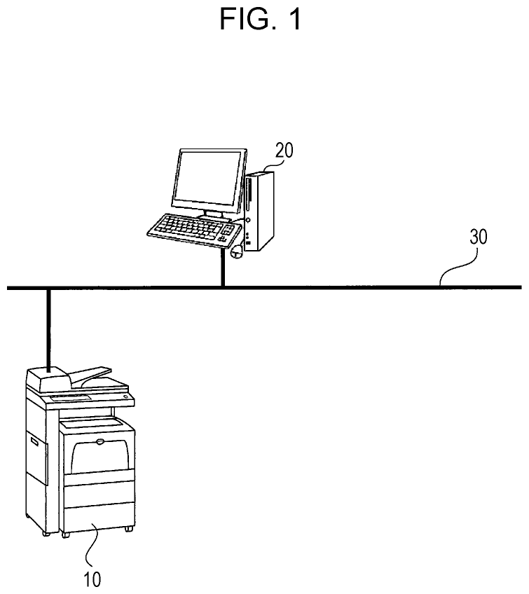

FIG. 1 is a diagram illustrating the configuration of an image forming system according to an exemplary embodiment of the present disclosure.

As illustrated in FIG. 1, the image forming system according to the exemplary embodiment of the present disclosure includes an image forming apparatus 10 and a terminal apparatus 20 which are connected to each other over a network 30.

The terminal apparatus 20 generates print data, and transmits the generated print data to the image forming apparatus 10 via the network 30. The terminal apparatus 20 is an information processing apparatus configured by installing, in a personal computer, programs for controlling the image forming apparatus 10.

The image forming apparatus 10 receives print data transmitted from the terminal apparatus 20, and outputs an image in accordance with the print data on a sheet. The image forming apparatus 10 is a so-called multifunction device having multiple functions, such as the print function, the scan function, the copying function, and the facsimile function. The image forming apparatus 10 is an information processing apparatus configured by installing programs for controlling operation screens on which operations for performing the multiple functions are carried out.

On an operation panel of the image forming apparatus, a hard ten-key pad may be disposed separately from the operation screens on which operations for performing the multiple functions are carried out. By using the hard ten-key pad, input operations on the operation screens may be performed. Applications of the image forming apparatus including such a hard ten-key pad are generated on the precondition of presence of the hard ten-key pad.

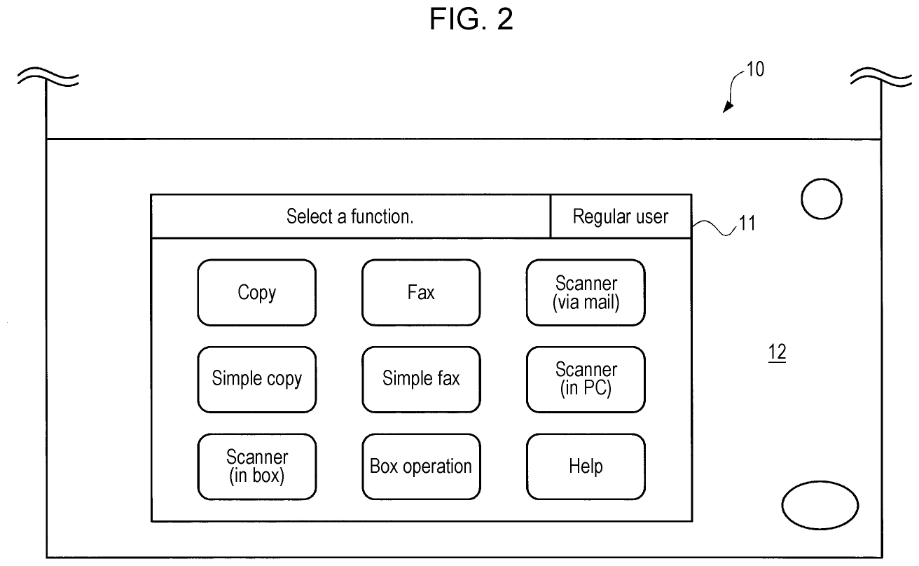

As illustrated in FIG. 2, a hard ten-key pad is sometimes not necessarily disposed on an operation panel 12 of the image forming apparatus 10 separately from an operation screen 11, and a ten-key screen, which illustrates a virtual ten-key pad, may be displayed on the operation screen 11, and input operations on the operation screen 11 may be performed. In this case, the ten-key screen is displayed so as to be superimposed on the current operation screen 11.

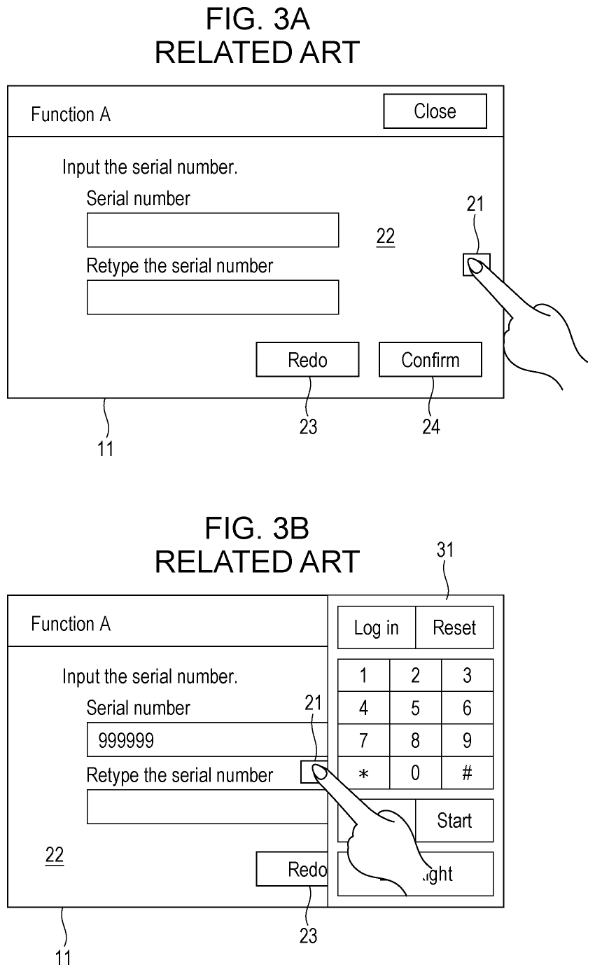

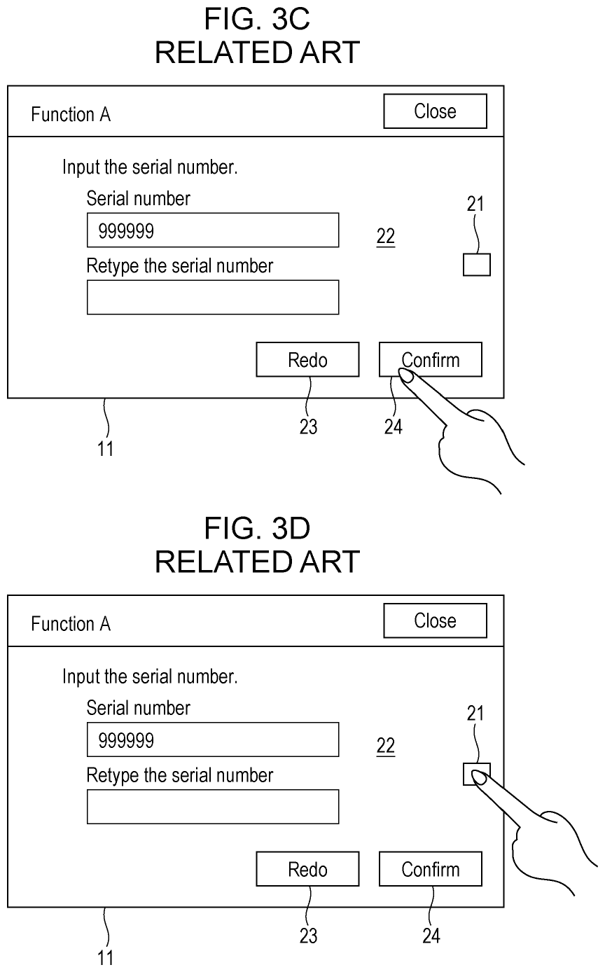

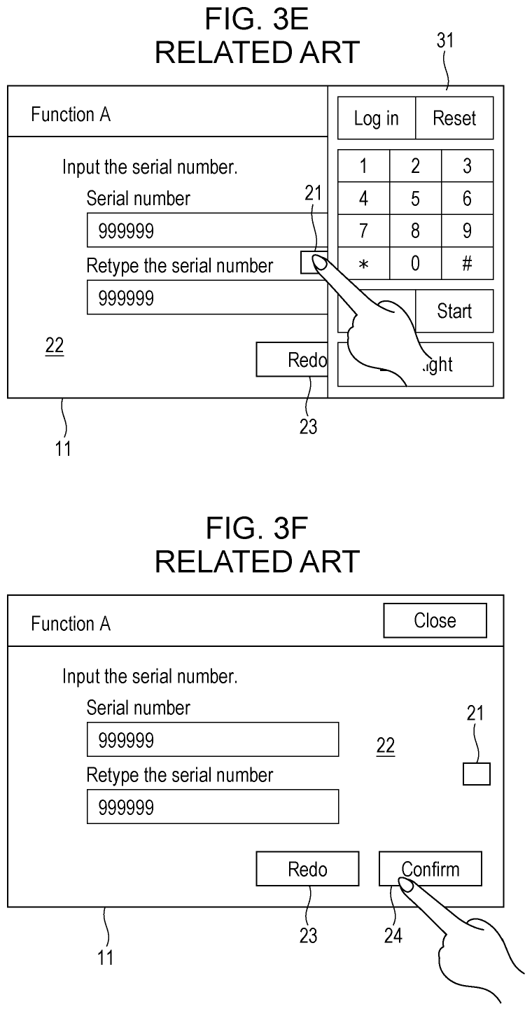

FIGS. 3A to 3F illustrate, as a comparison example, an operation example performed when a ten-key screen is DISPLAYED so as to be superimposed on the operation screen 11 of the image forming apparatus 10. Operations performed when a user inputs a serial number, which is the product number of the image forming apparatus, on an operation screen for system administration setting of the image forming apparatus will be described below.

On the operation screen 11, an input screen 22 as illustrated in FIG. 3A is displayed. In input of the serial number in the serial-number input field on the input screen 22, the user clicks a knob button 21 on the input screen 22.

When the knob button 21 is clicked, a ten-key screen 31 is displayed so as to be superimposed on the input screen 22 as illustrated in FIG. 3B. At that time, the ten-key screen 31 is displayed in a part of the display area of the input screen 22 in a superimposed manner, and objects 23 and 24, which are operation buttons, are hidden under the ten-key screen 31.

After input of a serial number using ten-key buttons on the ten-key screen 31, the user clicks the knob button 21 to close the ten-key screen 31. As illustrated in FIG. 3C, the user clicks the object 24 to confirm the operation of inputting a serial number.

As illustrated in FIG. 3D, to retype the serial number in a serial-number retyping field on the input screen 22, the user clicks the knob button 21 on the input screen 22.

When the knob button 21 is clicked, as illustrated in FIG. 3E, the ten-key screen 31 is displayed so as to be superimposed on the input screen 22.

After retyping the serial number by using ten-key buttons on the ten-key screen 31, the user clicks the knob button 21 to close the ten-key screen 31. As illustrated in FIG. 3F, the user clicks the object 24 to confirm the operation of retyping a serial number.

That is, in the comparison example, display of the ten-key screen 31 causes the objects 23 and 24 on the input screen 22 to be hidden, and operations on the objects 23 and 24 are incapable of being performed. Therefore, the ten-key screen 31 needs to be closed before operations on the objects 23 and 24. That is, the opened ten-key screen 31 hinders operations on the objects 23 and 24, leading to more operation steps.

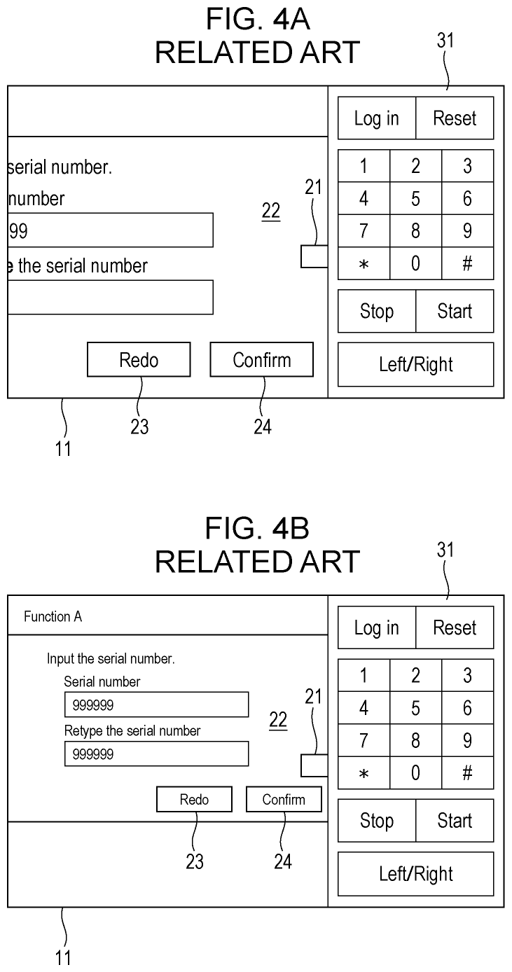

FIG. 4A illustrates, as a comparison example, an operation screen example obtained when the current operation screen is slid to the left direction for display so that the ten-key screen is not superimposed on the operation screen 11 of the image forming apparatus 10.

The example illustrated in FIG. 4A involves less operation steps than that in the processes in FIGS. 3A to 3F. However, when the knob button 21 is clicked and the ten-key screen 31 is displayed, the input screen 22, which is the current operation screen and which has been displayed in the display area of the operation screen 11, is slid, for display, in the −X direction by the display area of the ten-key screen 31. That is, the ten-key screen 31 is not superimposed on the input screen 22, and the objects 23 and 24 are displayed so as to be made operable. However, the whole input screen 22 is not included in the display area of the operation screen 11, and a part of the input screen 22 is located outside the display area of the operation screen 11 and is not displayed. When the input screen 22 is to be displayed in the entire area of the operation screen 11, information about how to close the ten-key screen 31 and display the input screen 22 which is under the ten-key screen 31 needs to be presented to a user through a message such as a banner. In addition, the ten-key screen 31 needs to be closed to display the input screen 22 which is under the ten-key screen 31, resulting in an increase in the number of operation steps. Further, display of a message such as a banner hinders operations, resulting in degradation of the operability.

FIG. 4B illustrates, as a comparison example, an operation screen example obtained when the current operation screen is reduced for display so that the ten-key screen 31 is not superimposed on the operation screen 11 of the image forming apparatus 10.

The example illustrated in FIG. 4B involves less operation steps than those in the processes in FIGS. 3A to 3F. However, when the knob button 21 is clicked to display the ten-key screen 31, the input screen 22, which is the current operation screen, is reduced by the display area of the ten-key screen 31 so that the whole input screen 22 is displayed in the display area of the operation screen 11. That is, the ten-key screen 31 is not superimposed on the input screen 22, and the objects 23 and 24 are displayed so as to be made operable. However, the objects on the input screen 22 are reduced and displayed in a smaller size, resulting in degradation of the operability. In addition, reduction of the size of characters displayed on the input screen 22 makes it difficult to check the input data, resulting in degradation of the operability.

In the present exemplary embodiment, even when, as illustrated in FIG. 3B, superimposition of the ten-key screen 31 on the input screen 22 hinders operations on the objects 23 and 24 on the lower input screen 22, the objects 23 and 24 on the lower input screen 22 may be operated without change of the display size and position of the lower input screen 22 as illustrated in FIGS. 4A and 4B.

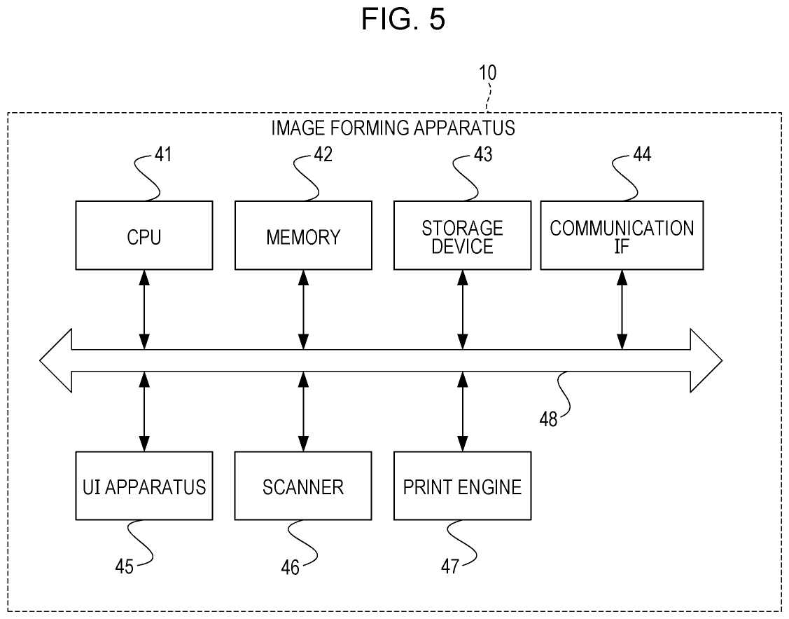

FIG. 5 is a diagram illustrating the hardware configuration of the image forming apparatus 10 according to the present exemplary embodiment.

As illustrated in FIG. 5, the image forming apparatus 10 includes a central processing unit (CPU) 41, a memory 42, a storage device 43 such as a hard disk drive, a communication interface (IF) 44 which performs data reception/transmission with external apparatuses and the like over the network 30, a user interface (UI) apparatus 45 including a touch panel or a liquid-crystal display and a keyboard, a scanner 46, and a print engine 47. These components are connected to each other through a control bus 48.

The print engine 47 prints an image on a recording medium such as a print sheet through processes, such as charging, exposure to light, developing, transfer, and fixing.

The CPU 41 is a processor which performs given processes on the basis of control programs stored in the memory 42 or the storage device 43 and which controls the operations of the image forming apparatus 10. In the present exemplary embodiment, the description will be made under the assumption that the CPU 41 reads, for execution, the control programs stored in the memory 42 or the storage device 43. The programs may be provided to the CPU 41 by storing the programs in a storage medium such as a compact disc-read-only memory (CD-ROM).

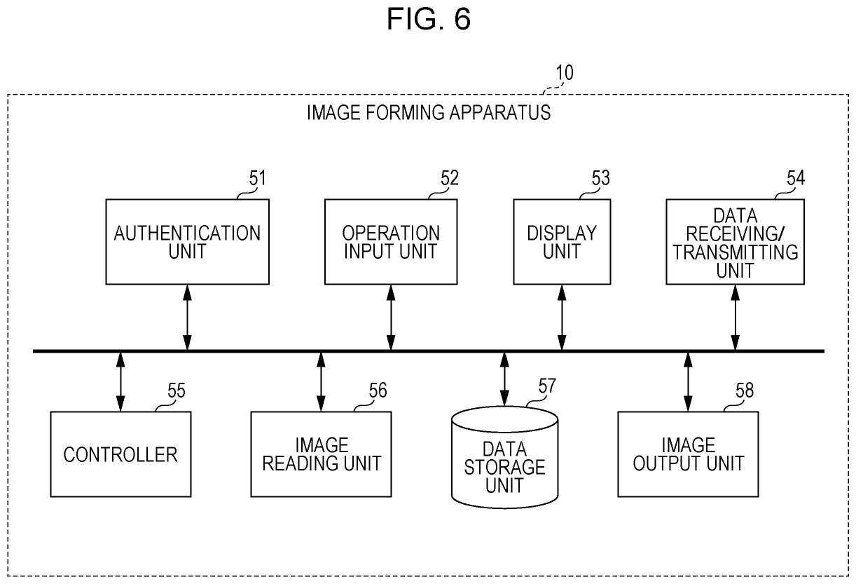

FIG. 6 is a block diagram illustrating the functional configuration of the image forming apparatus 10 implemented through execution of the control programs.

As illustrated in FIG. 6, the image forming apparatus 10 according to the present exemplary embodiment includes an authentication unit 51, an operation input unit 52, a display unit 53, a data receiving/transmitting unit 54, a controller 55, an image reading unit 56, a data storage unit 57, and an image output unit 58.

The data receiving/transmitting unit 54 performs data reception/transmission with external apparatuses such as the terminal apparatus 20.

The controller 55 exerts control so that print data is generated on the basis of print jobs received from the terminal apparatus 20 through the data receiving/transmitting unit 54, and the generated print data is output from the image output unit 58.

The data storage unit 57 stores various types of data such as print data generated by the controller 55. The data storage unit 57 stores an object management list and a move-target list which are described below.

The display unit 53, which is controlled by the controller 55, displays various types of information to users. The operation input unit 52 receives input of information about various operations performed by users.

The image output unit 58 outputs images on recording media such as print sheets on the basis of control exerted by the controller 55. The image reading unit 56 reads document images from documents, which have been set, on the basis of control exerted by the controller 55.

In display of at least two display areas on the display unit 53, the controller 55 determines whether superimposition of two display areas hinders operation buttons, which are located in a lower display area, from being operated. In other words, in display of at least two display areas on the display unit 53, if two display areas are superimposed on each other, the controller 55 detects an upper display area, and determines whether the upper display area includes operation buttons in the lower display area.

If the controller 55 determines that the upper display area includes operation buttons in the lower display area, instead of change of the display size and position of the lower display area, the controller 55 changes the arrangement positions of the operation buttons in the lower display area hidden by the upper display area so as to make the operation buttons operable. Specifically, the controller 55 changes the arrangement positions of the operation buttons in the lower display area hidden by the upper display area, to positions, which are not hidden by the upper display area, so as to make the operation buttons operable.

If the controller 55 determines that the upper display area includes no operation buttons in the lower display area, the controller 55 does not change the arrangement positions in the lower display area, and displays the at least two display areas on the display unit 53 as they are.

If change of the arrangement position of an operation button in the lower display area, which is hidden by the upper display area, causes superimposition of the operation button on a different object which is another display component, the controller 55 changes the arrangement position of the different object within the lower display area, and thus achieves arrangement of the operation button and the different object without superimposition.

If arrangement of the operation button and the different object in the lower display area without superimposition fails to be achieved, the controller 55 displays the operation button in the upper display area so that the operation button is made operable.

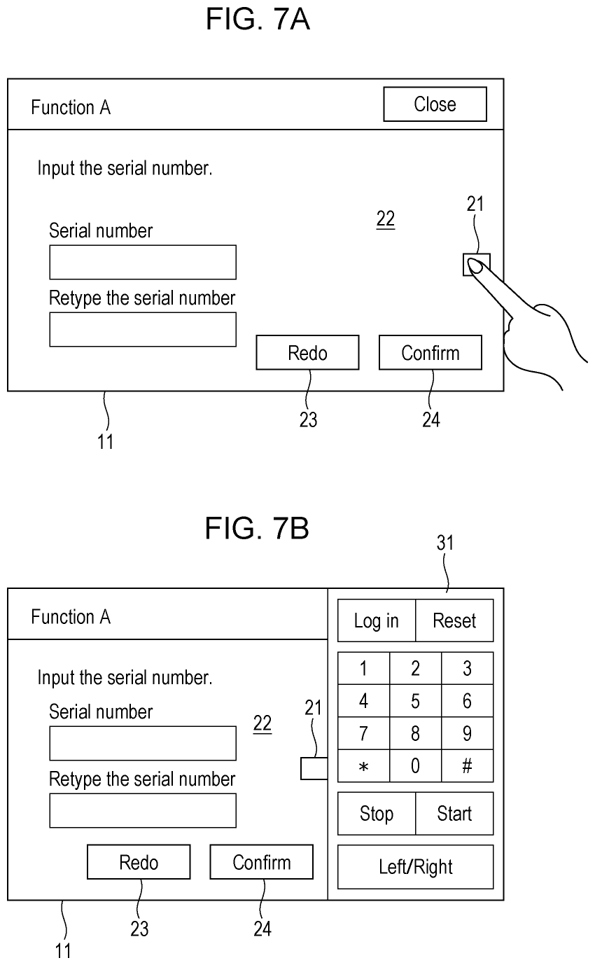

FIGS. 7A and 7B are diagrams illustrating an operation screen example of the image forming apparatus 10 according to the present exemplary embodiment.

As illustrated in FIG. 7A, in display of the input screen 22 on which input operations need to be performed by a user, the knob button 21 for displaying the ten-key screen 31 is displayed on the operation screen 11.

When the knob button 21 is clicked, as illustrated in FIG. 7B, the ten-key screen 31 is displayed so as to be superimposed on the input screen 22 which is the current display screen. The ten-key screen 31 is a display area for displaying operation buttons for assisting input operations on the lower input screen 22, and is a display area including, at least as a part, ten-key buttons used to input numerals on the lower input screen 22. At that time, the display size and position of the lower input screen 22 are not changed, and the arrangement positions of the objects 23 and 24, which are operation buttons in the lower input screen 22 hidden by the upper ten-key screen 31, are changed to positions, which are not hidden by the ten-key screen 31, so as to make the objects 23 and 24 operable.

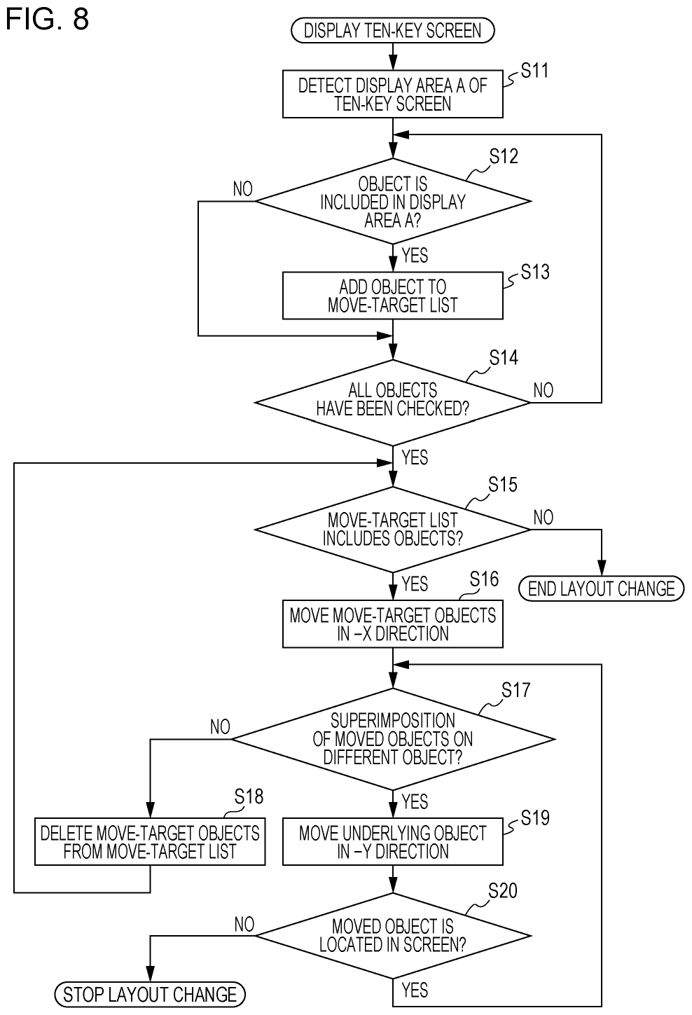

Operations performed by the image forming apparatus 10 until the operation screen 11 is changed from the state in FIG. 7A to the state in FIG. 7B will be described by using FIGS. 8 to 10B.

In the description below, the top-left corner of the operation screen 11 is regarded as the origin (0, 0). Each object is given an identifier (ID) for identifying the object. An object which is to be moved is given an ID for identifying the object as a move target. The data storage unit 57 stores the object management list which includes, for each object ID, information about the top-left coordinates (x, y) indicating the display position of the object and the display size (width, height) of the object. The data storage unit 57 stores the move-target list including move-target objects which are to be moved.

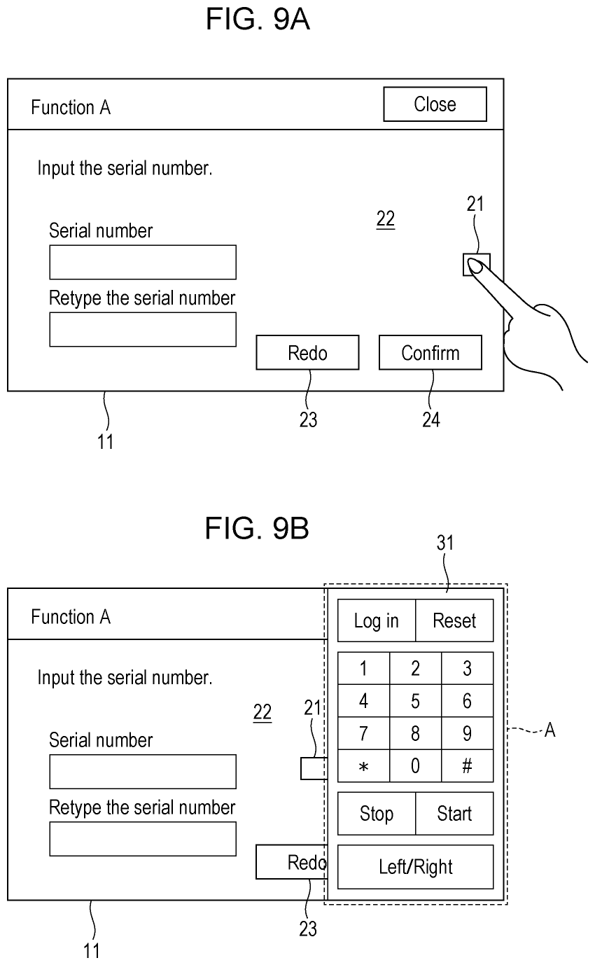

As illustrated in FIG. 9A, when the knob button 21 is clicked on the input screen 22, the operation of displaying the ten-key screen 31 starts.

In step S11, the controller 55 detects the display area A of the ten-key screen 31 which is to be displayed on the operation screen 11 of the image forming apparatus 10.

In step S12, the controller 55 determines whether an operation button object, which is an operation target, is included in the display area A.

If the controller 55 determines that an operation button object is included in the display area A in step S12, the controller 55 gives an ID as a move-target object to the object, which is determined to be included in the display area A, and adds the object to the move-target list in step S13. Specifically, as illustrated in FIG. 9B, the controller 55 gives an ID as a move-target object to the object 23, which is determined to be included in the display area A of the ten-key screen 31, and adds the object 23 to the move-target list.

If the controller 55 determines that an operation button object is not included in the display area A in step S12, the process proceeds to step S14.

In step S14, the controller 55 determines whether all the objects have been checked.

If the controller 55 determines that not all the objects have been checked in step S14, the process returns to step S12. Specifically, as illustrated in FIGS. 9A and 9B, the controller 55 gives an ID as a move-target object to the object 24, which is determined to be included in the display area A, and adds the object 24 to the move-target list.

If the controller 55 determines that all the objects have been checked in step S14, the controller 55 determines whether the move-target list includes move-target objects in step S15.

If the controller 55 determines that the move-target list includes no move-target objects in step S15, the layout change process ends, and the ten-key screen 31 is displayed in the upper display area without change of the display size and position of the lower display area.

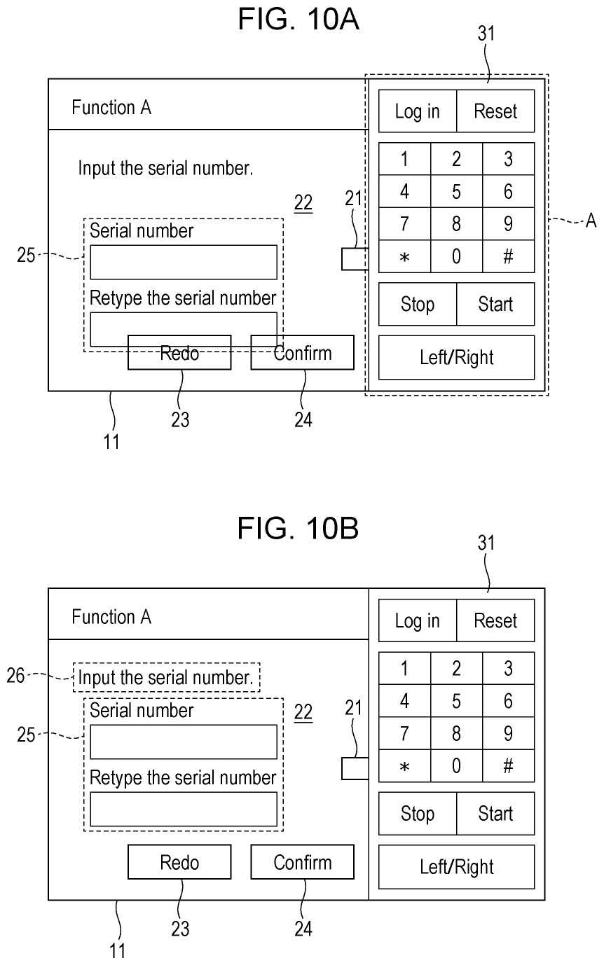

If the controller 55 determines that the move-target list includes move-target objects in step S15, in step S16, the controller 55 moves move-target objects, which are included in the move-target list, in the −X direction to a position outside the display area A in the operation screen 11. Specifically, the controller 55 determines that the move-target list includes the objects 23 and 24, and moves the objects 23 and 24 in the −X direction, in other words, in the left direction, to a position outside the display area A in the operation screen 11 as illustrated in FIGS. 9B and 10A.

In step S17, the controller 55 determines whether the move-target objects, which have been moved in the −X direction, are superimposed on a different object. Specifically, the controller 55 determines whether the objects 23 and 24 are superimposed on a different object.

If the controller 55 determines that the move-target objects, which have been moved in the −X direction in step S16, are not superimposed on a different object in step S17, the controller 55 deletes the moved move-target objects from the move-target list in step S18, and the process returns to step S15.

If the controller 55 determines that the move-target objects, which have been moved in the −X direction in step S16, are superimposed on a different object in step S17, the controller 55 moves the underlying object in the −Y direction in step S19. Specifically, the controller 55 determines that the objects 23 and 24 are superimposed on an object 25, and moves the object 25 in the −Y direction, in other words, in the upward direction, as illustrated in FIGS. 10A and 10B.

In step S20, the controller 55 determines whether the object, which has been moved in the −Y direction, is located in the display area of the operation screen 11.

If the controller 55 determines that the moved object is located in the display area of the operation screen 11 in step S20, the process proceeds to step S17.

Specifically, as illustrated in FIG. 10B, the controller 55 determines that the moved object 25 is located in the display area of the operation screen 11. In step S17, the controller 55 determines that the moved object 25 is not superimposed on an object 26 which is a different display component. In step S18, the controller 55 deletes the objects 23 and 24 from the move-target list. In step S15, the controller 55 determines that the move-target list includes no move-target objects, and ends the layout change process which is a process of changing the arrangement position of objects displayed in the display area under the ten-key screen 31.

That is, the display sizes of the objects 23, 24, 25, and 26 in the lower input screen 22 and the display position of the object 26 are not changed. The arrangement positions of the objects 23 and 24, which are operation buttons in the lower input screen 22 hidden by the upper ten-key screen 31, are changed to positions which are not hidden by the ten-key screen 31. Thus, while the ten-key screen 31 is displayed, the objects 23 and 24 are made operable.

If the controller 55 determines that the moved object is not located in the display area of the operation screen 11 in step S20, the controller 55 determines that arrangement of the operation button and the different object in the lower input screen 22 without superimposition fails to be achieved. The controller 55 stops the layout change process performed on objects displayed in the input screen 22 under the ten-key screen 31.

Operations performed by the image forming apparatus 10 in the case where the layout change process on objects displayed in the input screen 22 under the ten-key screen 31 is stopped, that is, in the case where arrangement of an operation button and a different object in the lower input screen 22 without superimposition fails to be achieved, will be described by using FIGS. 7A and 7B and 11A to 13B.

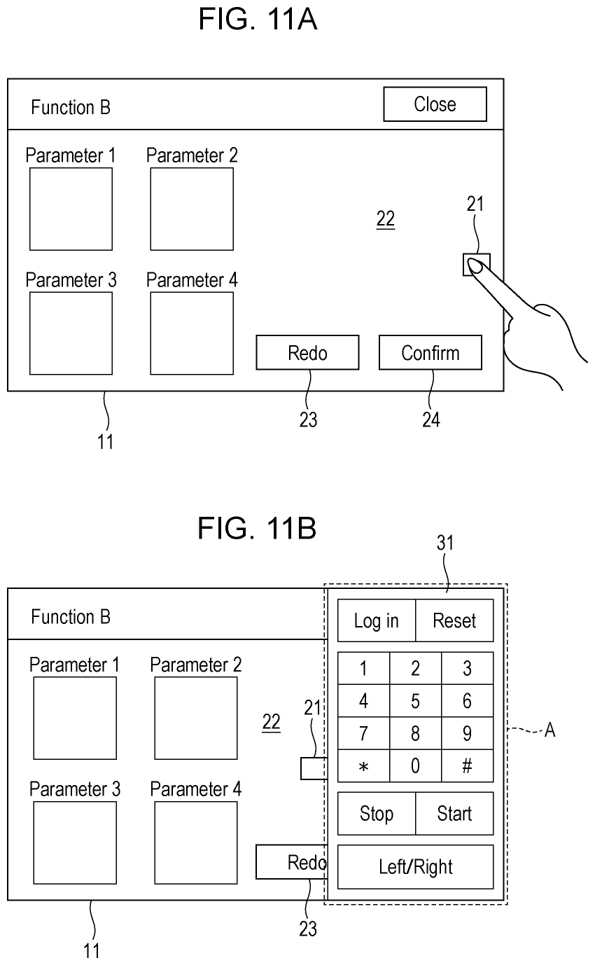

As illustrated in FIG. 11A, when the knob button 21 is clicked on the input screen 22, the operation of displaying the ten-key screen 31 starts.

In step S11, as illustrated in FIG. 11B, the controller 55 detects the display area A of the ten-key screen 31 which is to be displayed on the operation screen 11 of the image forming apparatus 10.

In step S12, the controller 55 determines that the operation button object 23, which is to be operated, is included in the display area A. In step S13, the controller 55 gives an ID as a move-target object to the object 23, and adds the object 23 to the move-target list.

In step S14, the controller 55 determines that not all the objects have been checked. In step S12, the controller 55 determines that the object 24 is included in the display area A. In step S13, the controller 55 gives an ID as a move-target object to the object 24, and adds the object 24 to the move-target list.

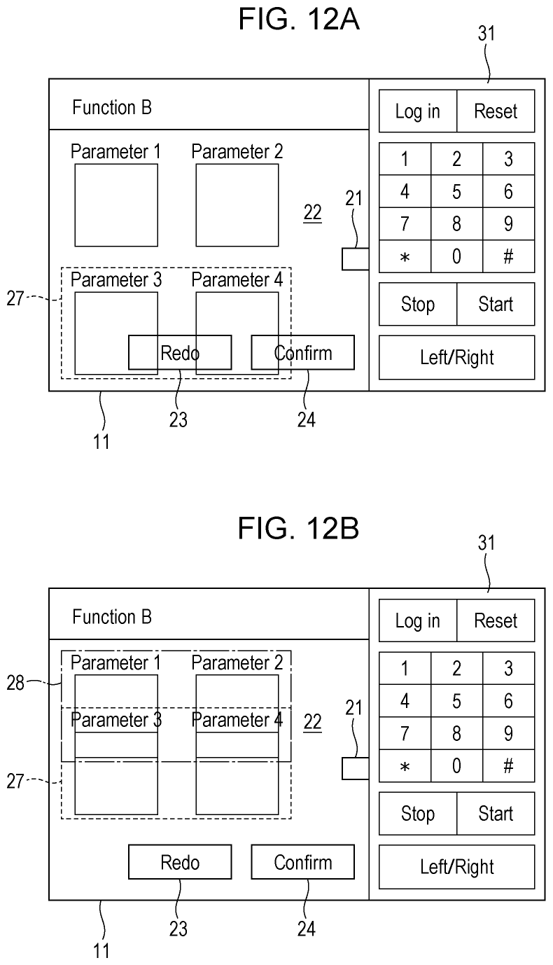

In step S14, the controller 55 determines that all the objects have been checked. In step S15, the controller 55 determines that the move-target list includes the objects 23 and 24. In step S16, the controller 55 moves the objects 23 and 24 in the −X direction, in other words, in the left direction, to a position outside the display area A in the operation screen 11 as illustrated in FIGS. 11B and 12A.

In step S17, the controller 55 determines that the objects 23 and 24, which have been moved in the −X direction, are superimposed on an object 27. In step S19, the controller 55 moves the underlying object 27 in the −Y direction, in other words, in the upward direction, as illustrated in FIGS. 12A and 12B.

In step S20, the controller 55 determines that the moved object 27 is located in the display area of the operation screen 11.

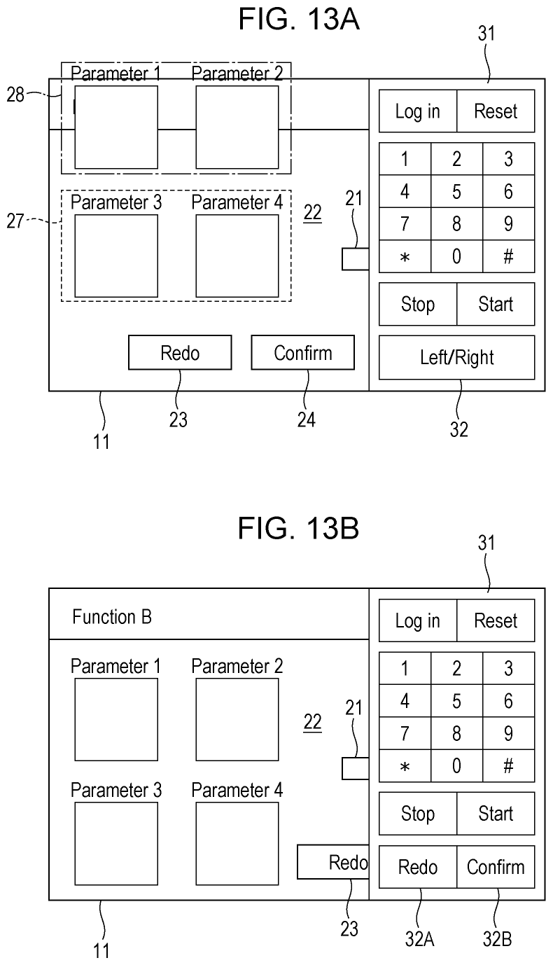

In step S17, as illustrated in FIG. 12B, the controller 55 determines that the moved object 27 is superimposed on an object 28. In step S19, the controller 55 moves the underlying object 28 in the −Y direction, in other words, in the upward direction, as illustrated in FIGS. 12B and 13A.

In step S20, the controller 55 determines that the moved object 28 is not located in the display area of the operation screen 11, and stops the layout change process performed on objects displayed on the input screen 22 under the ten-key screen 31.

The controller 55 generates objects in accordance with the number of operation button objects in the input screen 22, on which the ten-key screen 31 is superimposed, and assigns the generated objects in the ten-key screen 31. That is, as illustrated in FIG. 13B, the controller 55 assigns objects 32A and 32B, as operation buttons having the functions of the objects 23 and 24, in the upper ten-key screen 31.

Specifically, as illustrated in FIGS. 13A and 13B, for example, an object 32 in the ten-key screen 31 is divided into two objects. The objects 32A and 32B having the functions of the objects 23 and 24 are assigned, for display, to the objects, which are obtained through the division, so as to make the objects 23 and 24 operable. At that time, the display sizes and positions of the objects 23, 24, 27, and 28 in the input screen 22 under the ten-key screen 31 are not changed. The object 32 is an operation button for moving the ten-key screen 31 in the left/right direction, and the knob button 21 may be used as a substitute for the object 32.

Instead of assignment, to the object 32, of the objects 32A and 32B having the functions of the objects 23 and 24, the operation buttons such as the ten-key buttons in the ten-key screen 31 in the upper display area may be reduced. Below the object 32, operation buttons associated with the objects 23 and 24 may be generated and displayed, enabling the operations to be performed by using the operation buttons. Alternatively, some of the operation buttons in the ten-key screen 31, which is the upper display area, may be reduced. Operation buttons associated with the objects 23 and 24 may be generated and displayed in the free space, enabling the operations to be performed by using the operation buttons.

Thus, while the ten-key screen 31, which is the upper display area, is displayed, the objects 23 and 24, which are operation buttons in the display area under the ten-key screen 31, are made operable.

That is, without change of the display sizes and positions of the objects 23, 24, 27, and 28 in the lower input screen 22, the objects 23 and 24, which are operation buttons in the lower input screen 22 hidden by the upper ten-key screen 31, are disposed in the upper ten-key screen 31. While the ten-key screen 31 is displayed, the objects 23 and 24 are made operable.

That is, when arrangement of an operation button object and a different object in the lower input screen 22 without superimposition fails to be achieved, the operation button object is displayed in the upper display area so as to make the object operable. Not only in the case where arrangement, without superimposition, of an operation button object and a different object in the input screen 22, which is the lower display area, fails to be achieved, but also in different cases, an operation button in the input screen 22, which is the lower display area hidden by the ten-key screen 31 which is the upper display area, may be displayed in the upper display area so as to make the object operable.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### Modified Examples

In the exemplary embodiment described above, the case in which the controller 55 of the image forming apparatus 10 controls an operation screen is described. The present disclosure is not limited to this. The present disclosure is applicable similarly to the case in which a processer of an information processing apparatus, such as the terminal apparatus 20 or a server, connected over a network to the image forming apparatus 10 controls an operation screen of the image forming apparatus 10.

That is, in the exemplary embodiment described above, the case in which the operation panel implemented as a display apparatus in an information processing apparatus is used for display is described. The present disclosure is not limited to this. For example, the present disclosure encompasses the case in which a screen displayed on the operation panel of the image forming apparatus 10 is displayed on a different external display apparatus (for example, a smartphone or a tablet terminal). In this case, for example, an operation screen is displayed on a smartphone; an operation on the smartphone is transmitted to the image forming apparatus 10 over a network; the operation is carried out by the image forming apparatus 10.

That is, the exemplary embodiment is described by using an operation screen of the image forming apparatus 10 as an exemplary information processing apparatus. The present disclosure is not limited to this. The present disclosure is applicable similarly to an operation screen on a different information processing apparatus.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a memory; and
a processor configured to,
in display of at least two display areas on a display apparatus, when superimposition of two display areas hinders an operation using an operation button in the lower display area, change an arrangement position of the operation button in the lower display area hidden by the upper display area so as to make the operation button operable without change of a display size and a display position of the lower display area.

2. The information processing apparatus according to claim 1,
wherein the processor is configured to
change the arrangement position of the operation button in the lower display area hidden by the upper display area to a position so as to make the operation button operable, the position being not hidden by the upper display area.

3. The information processing apparatus according to claim 2,
wherein the processor is configured to,
when the change of the arrangement position of the operation button in the lower display area hidden by the upper display area causes superimposition of the operation button on a different display component, change an arrangement position of the different display component to a position within the lower display area so as to obtain arrangement without superimposition of the operation button on the different display component.

4. The information processing apparatus according to claim 3,
wherein the processer is configured to,
when the arrangement without superimposition of the operation button on the different display component in the lower display area fails to be obtained, display the operation button in the upper display area so as to make the operation button operable.

5. The information processing apparatus according to claim 1,
wherein the upper display area is a display area for displaying an operation button for assisting an input operation in the lower display area.

6. The information processing apparatus according to claim 2,
wherein the upper display area is a display area for displaying an operation button for assisting an input operation in the lower display area.

7. The information processing apparatus according to claim 3,
wherein the upper display area is a display area for displaying an operation button for assisting an input operation in the lower display area.

8. The information processing apparatus according to claim 4,
wherein the upper display area is a display area for displaying an operation button for assisting an input operation in the lower display area.

9. The information processing apparatus according to claim 5,
wherein the upper display area is a display area including, as at least a part, ten-key buttons used to input numerals in the lower display area.

10. The information processing apparatus according to claim 6,
wherein the upper display area is a display area including, as at least a part, ten-key buttons used to input numerals in the lower display area.

11. The information processing apparatus according to claim 7,
wherein the upper display area is a display area including, as at least a part, ten-key buttons used to input numerals in the lower display area.

12. The information processing apparatus according to claim 8,
wherein the upper display area is a display area including, as at least a part, ten-key buttons used to input numerals in the lower display area.

13. A non-transitory computer readable medium storing a program causing a computer to execute a process comprising:
in display of at least two display areas on a display apparatus, when superimposition of two display areas hinders an operation using an operation button in the lower display area, changing an arrangement position of the operation button in the lower display area hidden by the upper display area so as to make the operation button operable without change of a display size and a display position of the lower display area.

14. An information processing apparatus comprising:
means for storing data; and
means for, in display of at least two display areas on a display apparatus, when superimposition of two display areas hinders an operation using an operation button in the lower display area, changing an arrangement position of the operation button in the lower display area hidden by the upper display area so as to make the operation button operable without change of a display size and a display position of the lower display area.
